(19) United States
(12) Patent Application Publication
(10) Pub. No.: US 2003/0125430 A1
(43) Pub. Date: Jul. 3, 2003

(54) Transparent, flame retardant poly(arylene ether) blends

(76) Inventors: Adeyinka Adedeji, Albany, NY (US); Mark Vendon, Westerlo, NY (US)

Correspondence Address: CANTOR COLBURN, LLP, 55 GRIFFIN ROAD SOUTH, BLOOMFIELD, CT, 06002

(21) Appl. No.: 10/064,262

(22) Filed: Jun. 26, 2002

Related U.S. Application Data
(63) Continuation-in-part of application No. 09/539,067, filed on Mar. 30, 2000.

(51) Int. Cl. C08K 5/49

(52) U.S. Cl. 524/115

(57) ABSTRACT

A transparent, flame retardant poly(arylene ether) blend comprises a poly(arylene ether) resin, rubber-modified poly(styrene), optional impact modifier, optional poly (styrene), and an organic phosphate flame retardant or a mixture of organic phosphate flame retardants. Use of the organic phosphate flame retardants was unexpectedly found to provide flame retardance without affecting the transparency of objects molded from the blend.

### CROSS REFERENCE TO RELATED APPLICATIONS

This application is a continuation-in-part of U.S. application Ser. No. 09/539,067 filed Mar. 30, 2000.

### BACKGROUND OF THE INVENTION

Poly(arylene ether) polymers are a widely used class of thermoplastic engineering resins characterized by excellent hydrolytic stability, dimensional stability, toughness, heat resistance, and dielectric properties. Blends of these polymers further containing poly(styrene), and impact modifiers such as styrene-butadiene-styrene triblock copolymers (SBS) find particular utility in a number of applications, including plumbing fixtures, appliance and business machine housings, automotive parts, and electrical apparatus housings.

Commonly assigned U.S. Pat. No. 5,952,417 to Chao, for example, discloses a poly (arylene ether) resin blend that contains poly(styrene) and has improved heat performance characteristics. Commonly assigned U.S. Pat. No. 5,952,417 to Thompson discloses a thermoplastic polymer composition comprising a poly(arylene ether) resin and a styrenic homopolymer. Blends of poly(arylene) ether polymers and polyalkenylaromatic compounds (such as polystyrene) are commercially available. NORYL® is the trade name of one such blend that is sold commercially by the General Electric Company.

Although blends of poly(arylene ether) and poly(styrene) have been used for many applications, conventional blends have lacked the flame resistance needed for some applications. For instance, alternating current (AC) adapter housings must not only withstand structural impacts, they must also resist heat and flames. While additives are available to impart flame retardancy to these polymer blends, conventional additives also reduce the transparency of the finished product, and this loss of optical clarity is undesirable for some applications.

There accordingly remains a need in the art for a blend of poly(arylene ether), an impact modifier, and poly(styrene) that is flame retardant and that retains transparency in the finished product.

### BRIEF SUMMARY OF INVENTION

A transparent, flame retardant poly(arylene ether) blend comprises about 10 to about 90 weight % (wt. %) of a poly(arylene ether) resin, about 0 to about 80 wt. % of a poly(styrene) resin, about 5 to about 50 wt. % of a rubber-modified polystyrene, about 0 to about 15 wt. % of an impact modifier, and about 2 to about 35 wt. % of an organic phosphate flame retardant.

### DETAILED DESCRIPTION OF THE INVENTION

A transparent, flame retardant poly(arylene ether) blend comprises a poly(arylene ether) resin, rubber-modified poly(styrene), optional impact modifier, optional poly (styrene), and an organic phosphate flame retardant or a mixture of organic phosphate flame retardants. Use of the organic phosphate flame retardants was unexpectedly found to provide flame retardance without affecting the transparency of objects molded from the blend. Transparency is herein defined as permitting sufficient light through the material so as to perceive an object on the opposite side, although details of the object may or may not be clearly distinguishable.

The organic phosphate flame retardant is preferably an aromatic phosphate compound of the formula (I):

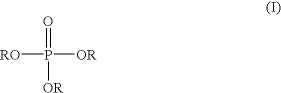

where R is the same or different and is alkyl, cycloalkyl, aryl, alkyl substituted aryl, halogen substituted aryl, aryl substituted alkyl, halogen, or a combination of any of the foregoing, provided at least one R is aryl.

Examples include phenyl bisdodecyl phosphate, phenylbisneopentyl phosphate, phenyl-bis (3,5,5′-tri-methyl-hexyl phosphate), ethyidiphenyl phosphate, 2-ethyl-hexyldi(p-tolyl) phosphate, bis-(2-ethylhexyl) p-tolylphosphate, tritolyl phosphate, bis-(2-ethylhexyl) phenyl phosphate, tri-(nonylphenyl) phosphate, di- (dodecyl) p-tolyl phosphate, tricresyl phosphate, triphenyl phosphate, dibutylphenyl phosphate, 2-chloroethyldiphenyl phosphate, p-tolyl bis(2,5,5′-trimethylhexyl) phosphate, 2-ethylhexyldiphenyl phosphate, and the like. The preferred phosphates are those in which each R is aryl. Especially preferred is triphenyl phosphate, which may be either unsubstituted or substituted, for example, isopropylated triphenyl phosphate.

Alternatively, the organic phosphate can be a di- or polyfunctional compound or polymer having the formula

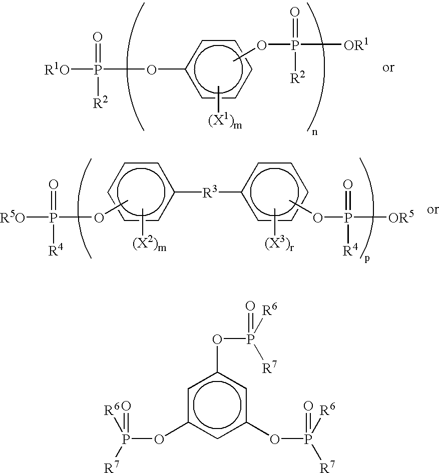

including mixtures thereof, in which R¹, R³ and R⁵ are, independently, hydrocarbon; R², R⁴, R⁶ and R⁷ are, independently, hydrocarbon or hydrocarbonoxy; X¹, X² and X³ are halogen; m and r are 0 or integers of 1 to 4, and n and p are from 1 to 30.

Examples include the bis diphenyl phosphates of resorcinol, hydroquinone and bisphenol-A, respectively, or their polymeric counterparts.

Methods for the preparation of the aforementioned di- and polyfunctional aromatic phosphates are described in British Patent No. 2,043,083.

Another development is the use of certain cyclic phosphates, for example, diphenyl pentaerythritol diphosphate, as a flame retardant agent for poly(arylene ether) resins, as is described by Axelrod in U.S. Pat. No. 4,254,775.

Also suitable as flame-retardant additives are compounds containing phosphorus-nitrogen bonds, such as phosphonitrilic chloride, phosphorus ester amides, phosphoric acid amides, phosphonic acid amides, phosphinic acid amides, tris (aziridinyl) phosphine oxide, or tetrakis(hydroxymethyl) phosphonium chloride. These flame-retardant additives are commercially available.

Preferred phosphate flame retardants include those based upon resorcinol such as, for example, resorcinol tetraphenyl diphosphate, as well as those based upon bis-phenols such as, for example, bis-phenol A tetraphenyl diphosphate. Phosphates containing substituted phenyl groups are also preferred.

In the final blend, the flame retardant is preferably present in at least the minimum amount necessary to impart a degree of flame retardancy to the blend to pass the UL-94 protocol at a rating of V-0, V-1, or V-2 depending on the specific application requirements. The particular amount will vary, depending on the molecular weight of the organic phosphate, the amount of the flammable resin present and possibly other normally flammable ingredients which might also be included in the blend. The organic phosphate flame retardants are generally present in the blends in amounts of about 2 to about 35 wt. %, preferably about 5 to about 30 wt. %, and most preferably about 10 to about 25 wt. %, based on the total weight of the blend.

The organic phosphate flame retardant can be combined with conventional poly (arylene ether) resins. Conventional poly(arylene ether) resins comprise a plurality of structural units of the formula (II):

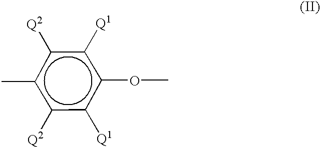

wherein for each structural unit, each Q¹ is independently hydrogen, halogen, primary or secondary lower alkyl (e.g., alkyl containing up to 7 carbon atoms), phenyl, haloalkyl, aminoalkyl, hydrocarbonoxy, or halohydrocarbonoxy wherein at least two carbon atoms separate the halogen and oxygen atoms; and each Q² is independently hydrogen, halogen, primary or secondary lower alkyl, phenyl, haloalkyl, hydrocarbonoxy or halohydrocarbonoxy as defined for Q¹. Preferably, each Q¹ is alkyl or phenyl, especially C₁₋₄ alkyl, and each Q² is hydrogen. The term poly (arylene ether) includes polyphenylene ether (PPE) and poly(arylene ether) copolymers; graft copolymers; poly(arylene ether) ether ionomers; and block copolymers of alkenyl aromatic compounds, vinyl aromatic compounds, and poly(arylene ether), and the like; and combinations comprising at least one of the foregoing; and the like.

Both homopolymer and copolymer poly(aryiene ether) polymers are included. The preferred homopolymers are those containing 2,6-dimethylphenylene ether units. Suitable copolymers include random copolymers containing, for example, such units in combination with 2,3,6-trimethyl-1,4-phenylene ether units or copolymers derived from copolymerization of 2,6-dimethylphenol with 2,3,6-trimethylphenol. Also included are poly(arylene ether) polymers containing moieties prepared by grafting vinyl monomers or polymers such as poly(styrene), as well as coupled poly(arylene ether) polymers in which coupling agents such as low molecular weight polycarbonates, quinones, heterocycles and formals undergo reaction in a known manner with the hydroxy groups of two poly(arylene ether) chains to produce a higher molecular weight polymer. Poly(arylene ether) polymers of the blend further include combinations of any of the above.

The poly(arylene ether) resin generally has a number average molecular weight of about 3,000 to about 40,000 and a weight average molecular weight of about 20,000 to about 80,000, as determined by gel permeation chromatography. The poly(arylene ether) resin generally has an intrinsic viscosity (IV) of about 0.10 to about 0.60 deciliters per gram (dl/g), preferably about 0.29 to about 0.48 dl/g, all as measured in chloroform at 25° C. It is also possible to utilize a high intrinsic viscosity poly(arylene ether) resin and a low intrinsic viscosity poly(arylene ether) resin in combination. Determining an exact ratio, when two intrinsic viscosities are used, will depend somewhat on the exact intrinsic viscosities of the poly(arylene ether) used and the ultimate physical properties that are desired.

The poly(arylene ether) resin is typically prepared by the oxidative coupling of at least one monohydroxyaromatic compound such as 2,6-xylenol or 2,3,6trimethylphenol. Catalyst systems are generally employed for such coupling; they typically contain at least one heavy metal compound such as a copper, manganese or cobalt compound, usually in combination with various other materials.

Particularly useful poly(arylene ether) resins are those which comprise molecules having at least one aminoalkyl-containing end group. The aminoalkyl radical is typically located in an ortho position to the hydroxy group. Products containing such end groups may be obtained by incorporating an appropriate primary or secondary monoamine such as di-n-butylamine or dimethylamine as one of the constituents of the oxidative coupling reaction mixture. Also frequently present are 4-hydroxybiphenyl end groups, typically obtained from reaction mixtures in which a by-product diphenoquinone is present, especially in a copper-halide-secondary or tertiary amine system. A substantial proportion of the polymer molecules, typically constituting as much as about 90 wt. % of the polymer, may contain at least one of said aminoalkyl-containing and 4-hydroxybiphenyl end groups.

It will be apparent to those skilled in the art from the foregoing that many poly (arylene ether)s are contemplated for use in the blend, and include those presently known, irrespective of variations in structural units or ancillary chemical features.

The poly(arylene ether) resin is typically present in an amount of about 10 to about 90 wt. %, preferably from about 10 to about 70 wt. %, and most preferably from about 30 to about 60 wt. % of the total blend.

Also optionally included in the blend is one or more poly(styrene) polymers. Useful poly(styrene) polymers include at least one polymer derived from one or more vinyl aromatic monomers in the described blend of general formula III:

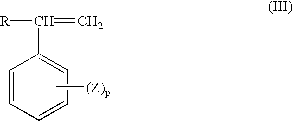

wherein R is hydrogen, a lower alkyl group or a halogen; Z is a hydrogen, vinyl group, a halogen, or a lower alkyl group; and p is from 0 to about 5. These resins include homopolymers of styrene, chlorostyrene, vinyl toluene, alpha-methyl styrene, bromostyrene, chlorostyrene, and dibromostyrene, as well as the polymers formed by the copolymerization of styrene with any of the substituted units listed above, particularly alpha-methyl styrene or dibromostyrene. Homostyrene resin, commonly called crystal polystyrene, is preferred.

Useful copolymers include random, radial, linear di-, linear tri- and/or tapered block copolymers. Random copolymers of styrene with one or more monomers such as acrylonitrile, butadiene, alpha-methylstyrene, ethylvinylbenzene, divinylbenzene and maleic anhydride may also be used, as well as rubber-modified polystyrenes comprising blends and grafts, wherein the rubber is a polybutadiene or a rubbery copolymer of about 50 to about 98 wt. % styrene and about 2 to about 50 wt. % diene monomer. A preferred rubber-modified polystyrene is FINACLEAR™ 520, available from Fina Oil and Chemical Company.

It is preferred, however, that when other vinyl aromatic monomers are employed, that they be present in amounts less than about 10 wt. %, and more preferably less than about 6.5 wt. % of the styrene. However, it is most preferred that the only vinyl aromatic monomer be styrene, so that the styrene polymer is a homopoly(styrene). The poly(styrene) polymer is used in amounts of 0 to about 80 wt. %, preferably about 10 to about 70 wt. %, and most preferably about 20 to about 50 wt. %. The rubber-modified poly(styrene) polymer is used in amounts of about 5 to about 50 wt. %, preferably about 10 to about 40 wt. %, and most preferably about 15 to about 35 wt. %

An impact modifier is commonly used to improve the impact properties of the molded blend. Although the SBS copolymer is one example of a block copolymer that can be used as an impact modifier, those skilled in the art will recognize that variations on the general structure shown in formula can alternatively be used, including, but not limited to, block copolymers of the A-B-A, A-B, A-B-C, and A-B-C-A types. Examples of these types are styrene-butadiene-styrene, styrene-butadiene, styrene-ethylene-butadiene, styrene-ethylene-propylene, styrene-ethylene-butadiene-styrene, and styrene-ethylene-propylene-styrene. Styrene acrylates are also useful as impact modifiers. Styrene-butadiene (SB) and styrene-butadiene-styrene (SBS) copolymers are preferred. The impact modifier is used in amounts of from 0 to about 15 wt. %, preferably 0 to about 10 wt. %, and most preferably from 0 to about 5 wt. %.

The transparent, flame retardant poly(arylene ether) may further optionally comprise various additives, for example, anti-oxidants, mold release agents, UV absorbers, stabilizers such as light stabilizers and others, lubricants, plasticizers, pigments, dyes, colorants, anti-static agents, blowing agents, and mixtures thereof. Exemplary antioxidants include organophosphites, for example, tris(nonyl-phenyl) phosphite, tris(2,4-di-t-butylphenyl)phosphite, bis(2,4-di-t-butylphenyl) pentaerythritol diphosphite, 2,4-di-tert-butylphenyl phosphite, or distearyl pentaerythritol diphosphite; alkylated monophenols, polyphenols and alkylated reaction products of polyphenols with dienes, such as, for example, tetrakis [methylene(3,5-di-tert-butyl-4-hydroxyhydrocinnamate)] methane and 3,5-di-tert-butyl-4-hydroxyhydrocinnamate octadecyl; butylated reaction products of para-cresol and dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds, such as, for example, distearylthiopropionate, dilaurylthiopropionate, ditridecylthiodipropionate; and amides of beta-(3,5-di-tert-butyl-4-hydroxyphenyl)-propionic acid. Fillers and reinforcing agents may also be used, such as, for example, silicates, titanium dioxide, fibers, glass fibers (including continuous and chopped fibers), carbon black, graphite, calcium carbonate, talc, and mica.

The preparation of the blend is normally achieved by mixing the solid components, preferably in powder form, and blending the components under conditions suitable for the formation of an intimate blend. When one or more components are liquid they may be added during the formation of the intimate blend. Conditions for formation of an intimate blend include solution blending or melt mixing in single or twin screw type extruders, mixing bowl, roll, kneader, or similar mixing devices that can apply a shear to the components. Twin screw extruders are often preferred due to their more intensive mixing capability over single screw extruders. It is often advantageous to apply a vacuum to the blend through at least one vent port in the extruder to remove volatile components in the blend. During mixing, the blend is preferably sufficiently heated such that the components are in the molten phase, thereby enabling intimate mixing. Typically temperatures up to about 300° C. can be employed, with about 150° C. to about 290° C. preferred, and about 180° C. to about 260° C. especially preferred.

The blend can be molded into useful articles, such as, for example, heat resistant containers, plumbing fixtures, appliance and business machine housings, automotive parts, electrical apparatus housings, and AC adapters by a variety of means such as, for example, injection molding, compression molding, thermoforming, and blow molding, among others conventionally known in the art.

As shown by the Examples below, it was unexpectedly found that the necessary degree of flame retardancy was only achieved by use of phosphate based flame retardant additives. In a particularly advantageous feature, use of even relatively high amounts of organic phosphate flame retardants resulted in blends having excellent transparency. In one embodiment, the composition after molding has a percent transmittance of at least 35%, preferably at least about 40%, more preferably at least about 50%, measured on a ⅛ inch thick sample using a cold white fluorescent light source.

The invention is further illustrated by the following non-limiting examples.

### EXAMPLES

The components used in the following examples are shown in Table 1 below. Melamine, melamine pyrophosphate, boron phosphate, and magnesium ammonium phosphate are all conventional flame retardant additives for poly(arylene ether) and poly(styrene) blends.

TABLE 1
[t1]

| Trade Name | Source | Component |
|---|---|---|
| 0.4 IV PPO ® | General Electric | Poly(arylene ether), IV = |
| | Plastics | 0.40 |
| 0.46 IV PPO ® | General Electric | Poly(arylene ether), IV = |
| | Plastics | 0.46 |
| FINA 520 | Fina Chemicals | Rubber-modified |
| | | polystyrene |
| PS EB3300 | BASF/Chevron | Polystyrene |
| HIPS GEH1897 | General Electric | High-impact polystyrene |
| | Plastics | |
| SBS D1102 | Shell Chemicals | Impact modifier |
| SMA | General Electric | Styrene/Maleic Acid |
| | Plastics | Copolymer |
| Melamine | Aldrich | Flame Retardant |
| Melamine | Aldrich | Flame Retardant |
| Pyrophosphate | | |
| Boron Phosphate | K and K Labs | Flame Retardant |
| Magnesium | Pfaltz & Bauer | Flame Retardant |
| ammonium phosphate | | |
| 71B | Akzo/FMC Corp. | Triphenyl phosphate |
| RDP | Akzo/Diahashi/Nagase | Resorcinol diphosphate |
| BPA-DP | Great Lakes Chemical | Bis-phenol A |
| | Corp. | diphosphate |
| HG90 Clay | Huber | Clay, avg. particle size |
| | | ≦20 microns |
| ZnO | G. H. Chemicals Ltd. | Zinc oxide |
| ZnS | Sachtleben | Zinc sulfide |
| R2175 Carbon Black | Cabot | Carbon black |
| G-1100 glass fibers | Owens Corning | 10 micron diameter glass |
| | | fibers |
| R10315 TiO₂ | Dupont | Titanium dioxide |

All blends were formulated by mixing the dry ingredients, compounding in a twin screw extruder and pelletizing the resulting material. When the flame retardant additive was a solid it was mixed with the dry ingredients. When the flame retardant additive was a liquid it was added during compounding in the extruder. After formulation, samples were molded by injection molding and tested. All measurements were at room temperature unless otherwise indicated.

Heat distortion temperature (HDT) was tested according to American Society for Testing Materials (ASTM) D648. Notched Izod in foot-pounds per inch was measured on ⅛ inches thick bars using ASTM D256. UnNotched Izod in foot-pounds per inch was measured on bars ⅛ inch thick using ASTM D256. Total energy in foot-ponds was measured on ⅛ inch thick, 4 inches diameter discs using ASTM D3763. Flexural modulus, in units of a thousand pounds per square inch (kpsi); flexural strength at yield in pounds per square inch (psi); and flexural Energy at break (psi) were measured ⅛ inch thick bars on using ASTM D790. Tensile strength at yield (psi), tensile strength at break (psi), and tensile elongation at break (psi) was measured on ⅛ inch thick bars using ASTM D638.

Flame retardancy was evaluated according to Underwriters Laboratory UL94 test procedure. The material is ignited and then the time is measured to determined how long it takes for the flame to extinguish. The amount of time is known as the flameout and is measured in seconds. A flameout of less than 10 seconds earns a V-0 UL rating. A flameout of less than 30 seconds earns a V-1 UL rating. A flameout less than 30 seconds (with dripping) earns a V-2 UL rating. The data in the Tables 2 and 3 is the average flameout value for 10, ⅛ inch bars. Transparency and percent transmittance were evaluated by measuring the percentage of light transmission through a ⅛ inch disk using a cold white fluorescent light source. Measurements of percent transmittance used a detection wavelength range of 300 to 700 nanometers.

Table 2 below presents data for seven blends wherein BPA-DP was used as flame retardant. The amount of each component shown is wt. %, based on the total weight of the blend.

TABLE 2
[t3]

| | Component | | | | | | |
|---|---|---|---|---|---|---|---|
| Material | 1 | 2 | 3 | 4 | 5 | 6 | 7 |
| 0.4 IV PPO | 30 | 30 | 48.13 | 40.21 | 47.5 | 60 | 80 |
| FINA520 | 5 | 30 | 14.58 | 10 | 30 | 5 | 5 |
| XPS EB3300 | 50 | 15 | 28.13 | 42.71 | 10 | 10 | 10 |
| BPA-DP | 15 | 25 | 5 | 5 | 12.5 | 25 | 5 |
| SBS D1102 | 0 | 0 | 4.14 | 2.06 | 0 | 0 | 0 |
| Properties | | | | | | | |
| HDT at 264 Psi | 162.6 | 126.4 | 212.1 | 205.5 | 177.2 | 159.7 | 265.8 |
| Notched Izod | 0.19 | 0.45 | 1.01 | 0.47 | 0.41 | 0.22 | 0.46 |
| Notched Izod, −20° F. | 0.50 | 0.66 | 1.14 | 0.69 | 0.78 | 0.39 | 0.71 |
| UnNotched Izod | 4.60 | 5.05 | 19.64 | 5.99 | 7.35 | 5.40 | 10.93 |
| UnNotched Izod, −20° F. | 4.50 | 5.90 | 13.19 | 9.29 | 8.92 | 4.87 | 9.90 |
| Energy to Failure | 1.15 | 0.68 | 30 | 1.01 | 0.66 | 1.05 | 3.24 |
| Total Energy | 1.27 | 0.69 | 31.57 | 1.03 | 0.67 | 1.07 | 3.31 |
| Energy to failure, −20° F. | 1.02 | 0.97 | 3.4 | 1.12 | 1.68 | 1.15 | 1.53 |
| Total Energy, −20° F. | 1.27 | 1.26 | 3.43 | 1.13 | 1.83 | 1.17 | 1.82 |
| Flexural Modulus | 460.3 | 294.2 | 388.8 | 426.1 | 360.2 | 433.8 | 416.2 |
| Flexural Strength at yield | 16030 | 10730 | 15680 | 16650 | 14970 | 18300 | 19460 |
| Tensile Strength at yield | 9265 | 7457 | 9746 | 10646 | 10442 | 10654 | 11920 |
| Tensile Strength at break | 9265 | 5677 | 7655 | 10240 | 8365 | 10654 | 11135 |
| Tensile, Elongation at | 5.65 | 16.31 | 12.52 | 9.46 | 12.32 | 7.28 | 11.92 |
| break | | | | | | | |
| Flameout Average 10 bars | 4.8 | 3.8 | 11.3 | 10.6 | 4.9 | 1.8 | 3.8 |
| ⅛ inches | | | | | | | |
| Transparent | Yes | Yes | Yes | Yes | Yes | Yes | Yes |
| % Transmission | 80.94 | 82.14 | 34.81 | 43.34 | 85.10 | 67.62 | 80.13 |

Table 3 presents four comparative examples (8-11) employing conventional flame retardant additives as well three examples (12-14) using organic phosphate flame retardants and one example (15) without flame retardant. All examples use the same resin blend.

TABLE 3
[t2]

| | Component | | | | | | | |
|---|---|---|---|---|---|---|---|---|
| Material | 8 | 9 | 10 | 11 | 12 | 13 | 14 | 15 |
| 0.4 IV PPO | 33.3 | 33.3 | 33.3 | 33.3 | 33.3 | 33.3 | 33.3 | 33.33 |
| FINA520 | 25 | 25 | 25 | 25 | 25 | 25 | 25 | 25 |
| XPS E8B300 | 33.33 | 33.33 | 33.33 | 33.33 | 33.33 | 33.33 | 33.33 | 33.33 |
| Melamine | 8.333 | | | | | | | |
| Melamine | | 8.333 | | | | | | |
| Pyrophosphate | | | | | | | | |
| Boron Phosphate | | | 8.333 | | | | | |
| Magnesium | | | | | | | | |
| Ammonium Phosphate | | | | 8.333 | | | | |
| 71B | | | | | 8.333 | | | |
| RDP | | | | | | 8.33 | | |
| BPA-DP | | | | | | | 8.33 | |
| Properties | | | | | | | | |
| Specific Gravity | | | | | | | 1.08 | 1.06 |
| HDT at 264 Psi | 232.7 | 233.9 | 234.1 | 239.2 | 191.6 | 192 | 211 | 233.9 |
| Notched Izod | 0.46 | 0.4 | 0.4 | 0.43 | 0.49 | 0.51 | 0.37 | 0.39 |
| Notched Izod, −20° F. | 0.48 | 0.44 | 0.44 | 0.47 | 0.49 | 0.49 | — | — |
| UnNotched Izod | | | 3.94 | 4.52 | 5.06 | 6.26 | 5.94 | 6.68 |
| UnNotched Izod, 20° F. | | | 4.93 | 4.52 | 4.79 | 5.41 | | |
| Energy to Failure | 3.33 | 3.9 | 2.77 | 3.62 | 2.09 | 1.45 | 2.26 | 2.86 |
| Total Energy | 3.35 | 3.92 | 2.79 | 3.64 | 2.12 | 1.8 | 2.3 | 2.96 |
| Energy to Failure, | 3.26 | 3.11 | 2.22 | 2.66 | 1.81 | 0.94 | 2.52 | 3.26 |
| −20° F. | | | | | | | | |
| Total Energy, −20° F. | 3.28 | 3.13 | 2.23 | 2.67 | 1.82 | 1.47 | 2.54 | 3.3 |
| Flexural Modulus | 431.0 | 420.6 | 421.1 | 424.4 | 397.5 | 388.7 | 394.6 | 385.3 |
| Flexural Strength | 15110 | 15530 | 16090 | 15850 | 15920 | 15950 | 15950 | 15790 |
| at yield | | | | | | | | |
| Tensile Strength | 8777 | 9147 | 9778 | 9576 | 10080 | 9921 | 10211 | 10138 |
| at yield | | | | | | | | |
| Tensile Strength | 8708 | 9089 | 9778 | 9576 | 10010 | 7018 | 8987 | 8551 |
| at break | | | | | | | | |
| Tensile Elongation | 9.67 | 9.27 | 9.1 | 8.88 | 9.76 | 11.51 | 10.41 | 11 |
| at break | | | | | | | | |
| Flameout Average | Fail | Fail | Fail | Fail | 6.6 | 7.6 | 12.0 | Fail |
| 10 bars ⅛inch | | | | | | | | |
| Transparent | No | No | No | No | Yes | Yes | Yes | Yes |
| % Transmission | 6.64 | 9.86 | 33.40 | 7.09 | 64.05 | 74.45 | 63.97 | 82.14 |

[t4]

As shown in the Tables, phosphate additives effectively impart flame retardant character to a poly(arylene ether) blend comprising a poly(arylene ether), a rubber-modified polystyrene, optional poly(styrene) and optional impact modifier. Surprisingly, as shown in examples 1-7 and 12-14, blends with good flameout averages were also transparent.

Table 4, below, presents two additional comparative examples. Example 16 is intended to approximate Example 5 from U.S. Pat. No. 6,165,309 to Burnell et al. Example 17 is intended to approximate Example 4 from U.S. Pat. No. 4,948,832 to Ostermayer et al. Molded samples were prepared and tested for transparency as described above. As indicated in Table 4, both samples were opaque.

TABLE 4
[t5]

Component

| Material | 16 | 17 |
|---|---|---|
| 0.46 IV PPO | 53.2 | 46.0 |
| SMA | 4.0 | 4.0 |
| HIPS GEH1897 | 12.0 | 16.0 |
| RDP | 5.0 | |
| HG90 clay | 25.0 | |
| ZnO | 0.15 | |
| ZnS | 0.15 | |
| R2175 Carbon Black | 0.5 | |
| 10 micron glass fibers | | 30.0 |
| TiO₂ | | 4.0 |
| Properties | | |
| Transparent | No | No |
| % Transmission | 0.00 | 0.00 |

The blend described above has the advantage of being flame-retardant and transparent, which is a combination not seen in the prior art for NORYL®-type plastic. Since it is both flame-retardant and transparent, the blend can be used in any application that requires resistance to heat and/or flame, and transparency. Heat resistant containers, plumbing fixtures, appliance and business machine housings, automotive parts, electrical apparatus housings, and AC adapters are examples of some useful applications.

While preferred embodiments have been shown and described, various modifications and substitutions may be made thereto without departing from the spirit and scope of the invention. Accordingly, it is to be understood that the present invention has been described by way of illustrations and not limitation.

1. A poly(arylene ether) blend comprising, based on 100 wt. % of the total blend:
about 10 to about 90 wt. % of a poly(arylene ether) resin;
about 5 to about 50 wt. % of a rubber-modified poly(styrene) resin that is a tapered block copolymer; and
about 2 to about 35 wt. % of an organic phosphate flame retardant;
wherein the blend has a percent transmittance after molding of at least about 35% measured at ⅛ inch thickness.

2. The poly(arylene ether) blend of claim 1, wherein the organic phosphate flame retardant is the bis diphenyl phosphate of bis-phenol A.

3. The poly(arylene ether) blend of claim 1, wherein the organic phosphate flame retardant is triphenylphosphate.

4. The poly(arylene ether) blend of claim 1, wherein the organic phosphate flame retardant is the bis diphenyl phosphate of resorcinol.

5. The poly(arylene ether) blend of claim 1, wherein the poly(arylene ether) resin comprises a plurality of structural units of the formula (II): 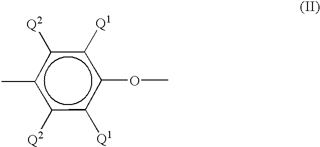
wherein for each structural unit, each Q¹ is independently hydrogen, halogen, primary or secondary lower alkyl having up to about 7 carbon atoms, phenyl, haloalkyl, aminoalkyl, hydrocarbonoxy, or halohydrocarbonoxy wherein at least two carbon atoms separate the halogen and oxygen atoms; and each Q² is independently hydrogen, halogen, primary or secondary lower alkyl having up to 7 carbon atoms, phenyl, haloalkyl, hydrocarbonoxy or halohydrocarbonoxy wherein at least two carbon atoms separate the halogen and oxygen atoms.

6. The poly(arylene ether) blend of claim 5, wherein each Q¹ is an alkyl group having from 1 to 4 carbon atoms, and each Q² is hydrogen.

7. The poly(arylene ether) blend of claim 1, wherein the poly(arylene ether) resin is selected from the group consisting of homopolymer resins containing 2,6-dimethylphenylene ether units, random copolymer resins having 2,6-dimethylphenylene ether units in combination with 2,3,6-trimethyl-1,4-phenylene ether units, and copolymer resins derived from copolymerization of 2,6-dimethylphenol with 2,3,6-trimethylphenol.

8. The poly(arylene ether) blend of claim 1, wherein the rubber-modified poly (styrene) comprises up to about 50% diene monomer units.

9. The poly(arylene ether) blend of claim 1, further comprising about 1 to about 80 wt. % of a poly(styrene) resin.

10. The poly(arylene ether) blend of claim 9, wherein the poly(styrene) resin is formed from one or more monomers having the formula (III): 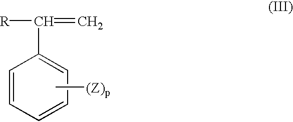
wherein R is hydrogen, a lower alkyl group having from 1 to 7 carbons, or a halogen; Z is a vinyl group, a halogen, or a lower alkyl group having from 1 to 7 carbon atoms; and p is from 0 to 5.

11. The poly(arylene ether) blend of claim 9, wherein the poly(styrene) resin is formed from one or more of styrene, chlorostyrene, vinyltoluene, alpha-methyl styrene, bromostyrene, dichlorostyrene, and dibromostyrene.

12. The poly(arylene ether) blend of claim 9, wherein the poly(styrene) resin is a homopoly(styrene).

13. The poly(arylene ether) blend of claim 9, wherein the poly(styrene) resin is derived from styrene and up to about 10 wt. % monomers having the formula (III) wherein R is a lower alkyl group having from 1 to 7 carbons or a halogen.

14. The poly(arylene ether) blend of claim 1 further comprising about 1 to about 15 wt. % of an impact modifier.

15. The poly(arylene ether) blend of claim 14, wherein the impact modifier is selected from the group consisting of styrene-butadiene-styrene, styrene-butadiene, styrene-ethylene-butadiene, styrene-ethylene-propylene, styrene-ethylene-butadiene-styrene, styrene-ethylene-propylene-styrene, styrene acrylates, and combinations comprising at least one of the foregoing.

16. The poly(arylene ether) blend of claim 15, wherein the impact modifier is a styrene-butadiene or a styrene-butadiene-styrene block copolymer.

17. The poly(arylene ether) blend of claim 1, further comprising one or more of fillers, anti-oxidants, mold release agents, UV absorbers, stabilizers, lubricants, plasticizers, pigments, dyes, colorants, anti-static agents, and blowing agents.

18. A transparent poly(arylene ether) blend comprising, based on 100 wt. % of the total blend:
about 10 to about 70 wt. % of a poly(arylene ether) resin;
about 10 to about 40 wt. % of a rubber-modified poly(styrene) resin that is a tapered block copolymer;
about 10 to about 70 wt. % of a poly(styrene) resin;
about 0 to about 10 wt. % of an impact modifier; and
about 5 to about 30 wt. % of an organic phosphate flame retardant;
wherein the blend has a percent transmittance after molding of at least about 35% measured at ⅛ inch thickness.

19. A transparent poly(arylene ether) blend comprising, based on 100 wt. % of the total blend:
about 30 to about 60 wt. % of a poly(arylene ether) resin;
about 15 to about 35 wt. % of a rubber-modified poly(styrene) resin that is a tapered block copolymer;
about 20 to about 50 wt. % of a poly(styrene) resin;
about 0 to about 5 wt. % of a impact modifier; and
about 10 to about 25 wt. % of an organic phosphate flame retardant;
wherein the blend has a percent transmittance after molding of at least about 35% measured at ⅛ inch thickness.

20. The poly(arylene ether) blend of claim 1, wherein the blend has a UL rating of V-0.

21. The poly(arylene ether) blend of claim 1, wherein the blend has a UL rating of V-1.

22. The poly(arylene ether) blend of claim 1, wherein the blend has a UL rating of V-2.

23. The poly(arylene ether) blend of claim 1, wherein after being set on fire the blend will extinguish itself in about 10 seconds or less.

24. The poly(arylene ether) blend of claim 1, wherein after being set on fire the blend will extinguish itself in about 20 seconds or less.

25. The poly(arylene ether) blend of claim 1, wherein after being set on fire the blend will extinguish itself in about 30 seconds or less.

26. The poly(arylene ether) blend of claim 1, wherein the poly(arylene ether) resin has a number average molecular weight of about 3,000 to about 40,000 and a weight average molecular weight of about 20,000 to about 80,000, as determined by gel permeation chromatography.
